(19) United States
(12) Patent Application Publication
(10) Pub. No.: US 2014/0178077 A1
(43) Pub. Date: Jun. 26, 2014

(54) System and Method for Transmitting Multi-Octave Telecommunication Signals by Up-Shifting into a Sub-Octave Bandwidth

(71) Applicant: Titan Photonics, Inc., Fremont, CA (US)

(72) Inventors: Chen-Kuo Sun, Escondido, CA (US); Charlie Chen, Santa Clara, CA (US); Eric Liu, Fremont, CA (US)

(73) Assignee: Titan Photonics, Inc., Fremont, CA (US)

(21) Appl. No.: 14/069,248

(22) Filed: Oct. 31, 2013

Related U.S. Application Data
(63) Continuation-in-part of application No. 13/645,292, filed on Oct. 4, 2012.
Application No. 13/645,292 is a continuation-in-part of application No. 13/585,653, filed on Aug. 14, 2012.

(51) Int. Cl. H04B 10/2575

(52) U.S. Cl. CPC H04B 10/2575
USPC 398/115

(57) ABSTRACT

A system for transporting a plurality of digital data streams over an optical fiber can include a plurality of upstream quadrature amplitude modulation (QAM) modems. Each QAM modem encodes a digital stream onto a carrier signal by modulating both the amplitude and the phase of the carrier signal. Each QAM modem also up-shifts the signal frequency, with each up-shifted signal having a frequency within a single sub-octave frequency band to suppress composite second order distortions that can occur during optical transport. The QAM signals are combined and converted to an optical signal that is transmitted over an optical fiber to a receiver. To convert the signal, a voltage source is connected with an electro-absorption modulator to provide a bias voltage for altering an optical power of the optical signal with a DC offset. The DC offset minimizes third order distortions of signals transmitted on the fiber optic.

This application is a continuation-in-part of application Ser. No. 13/645,292, filed Oct. 4, 2012, which is a continuation-in-part of application Ser. No. 13/585,653, filed Aug. 14, 2012, both of which are currently pending. The contents of application Ser. No. 13/585,653 and application Ser. No. 13/645,292 are hereby incorporated herein by reference.

### FIELD OF THE INVENTION

The present invention pertains generally to systems and methods for transporting multi-octave telecommunication signals using an optical fiber. More particularly, the present invention pertains to systems and methods for simultaneously transporting a plurality of telecommunication signals over an optical fiber with reduced second order distortions. The present invention is particularly, but not exclusively, useful for systems and methods that up-shift a plurality of information signals onto carrier signals within a single sub-octave radio-frequency (RF) band for subsequent conversion to a light beam that is configured for optical transmission over an optical fiber.

### BACKGROUND OF THE INVENTION

Modernly, there is a need to transport digital data streams over relatively long distances using point-to-point and point-to-multipoint connections. In this regard, optical fibers can be used to transport signals over relatively long distances with relatively low signal distortion or attenuation, as compared with copper wire or co-axial cables.

One way to transport digital information across an optical fiber is to encode the digital signal on an analog carrier signal (e.g. RF signal) using a modem. Next, the RF signal can be converted into a light beam signal using an optical transmitter such as a laser diode, and then introduced into an end of an optical fiber. In this process, more than one light signal can be transmitted at one time. Typically, to accommodate the transport of a large volume of information, a relatively large bandwidth RF signal, having a multi-octave bandwidth, is converted and transmitted over the optical fiber. For these multi-octave optical transmissions, composite second order distortions caused by fiber dispersion can cause significant signal degradation at optical transport distances of about 1 km, or more.

In simple systems, digital streams are encoded on an RF carrier signal by modulating the amplitude, phase or frequency of the carrier signal. To increase the amount of information that a carrier signal can convey, techniques have been established which allow modulation of both the amplitude and phase of the carrier signal. One such technique is commonly referred to as quadrature amplitude modulation (QAM). In this technique, the amplitudes of two carrier waves that are out of phase with each other by 90° are modulated by two digital streams. The two carrier waves are summed and the resultant waveform includes a combination of phase modulation and amplitude modulation. Because the two carrier waves differ in phase by 90°, the resultant (summed) waveform can be separated, after transport, into the two original carrier signals without cross-talk between the carrier signals.

As indicated above, multi-octave optical transmissions can result in composite second order distortions which can adversely affect system fidelity. These composite second order distortions can occur when using QAM techniques, for example, when the two RF signals are transported that do not reside within a single, sub-octave band.

In light of the above, it is an object of the present invention to provide a system and method for optically transporting a plurality of signals over a single optical fiber over distances greater than about 1 km. Another object of the present invention is to provide a system and method for reducing the adverse effects of composite second order distortions during optical transport of digital signals that have been modulated on a carrier signal using a technique which includes both phase modulation and amplitude modulation. It is another object of the present invention to reduce the effects of composite second order distortions on systems utilizing QAM techniques to encode digital streams onto carrier signals. Still another object of the present invention is to provide systems and methods for transmitting multi-octave telecommunication signals by up-shifting into a sub-octave bandwidth that are easy to use, relatively easy to manufacture, and comparatively cost effective.

### SUMMARY OF THE INVENTION

In accordance with the present invention, a system for transporting a plurality of digital data streams over an optical fiber can include a plurality of upstream quadrature amplitude modulation (QAM) modems. Each QAM modem encodes a digital stream onto a carrier signal by modulating both the amplitude and the phase of the carrier signal. The frequency of each modulated carrier signal is within a single sub-octave frequency band to suppress composite second order distortions that can occur during optical transport. Once modulated, the signals are combined. Once combined, the combined signal is converted to an optical signal and transmitted over an optical fiber to a receiver.

In more detail, each QAM modem includes an upstream signal processor for mapping symbols from the digital data stream into an I-component and a Q-component. In addition, each QAM modem includes an upstream I-Q mixer for establishing the I-component as an in-phase I-signal with an RF carrier frequency, f, and for phase shifting the Q-component into a quadrature-phase Q-signal with the same RF carrier frequency f. For this purpose, a local oscillator can be incorporated into the upstream I-Q mixer for use when establishing the phase relationship between the I-signal and the Q-signal. To unite the I-signal and the Q-signal, each QAM modem includes a summer which receives signals from the upstream I-Q mixer and outputs a modulated carrier signal.

In another embodiment, each QAM modem can include a pair of high-speed digital to analog (D/A) converters. One of the high speed digital to analog (D/A) converters receives a first digital stream and produces an analog, I-signal output. In producing the I-signal output, a calculated LO signal having frequency, f, is used, wherein f is between a frequency f_{L} and a frequency f_{H}, and f_{H}<2 f_{L}. The other high speed digital to analog (D/A) converter receives a second digital stream and produces an analog, Q-signal output. In producing the Q-signal output, a calculated LO signal having the frequency, f, is used with the Q-signal calculated LO signal differing in phase from the I-signal calculated LO signal by ninety degrees. For this embodiment, an I-Q mixer having a physical local oscillator is not necessarily required.

At each QAM modem, each signal is also up-shifted during modulation such that the frequency of the output I-signal and the output Q-signal are within a sub-octave broadband wherein f is between a frequency f_{L} and a frequency f_{H}, wherein f_{H}<2 f_{L}. In comparison with the bandwidth requirements for a wireless communication system, an up-shifted signal for a fiber optic communication system will typically need a relatively wider bandwidth. For the present invention, however, the up-shifted signal f must still be a sub-octave broadband signal. In detail, the up-shifted signal f will be within a bandwidth between a low frequency f_{L} and a high frequency f_{H}. By definition, f_{H} must be less than twice f_{L}. Moreover, although f_{H} is less than twice f_{L}, it will also need to be approximately equal to twice f_{L}. Thus, the sub-octave bandwidth requirements for the RF frequency f of the up-shifted signal can be expressed as: f_{L}<f<f_{H}; f_{H}<2 f_{L}; and f_{H}\tilde{=} 2 f_{L}. With this cooperative interaction of structure, composite second order distortions that can occur during optical transport are suppressed. Once modulated, the signals are combined and converted to an optical signal that is directed into an optical fiber.

To convert the combined RF signal into an optical signal, the system includes a light source for generating a light beam having a wavelength λ and an electrical-optical (EO) converter. Structurally, the electrical-optical (EO) converter is connected to the summer and to the light source to create an optical signal λ carrying the I-signal together with the Q-signal, for transmission over the fiber optic.

In one embodiment, the EO converter is an electro-absorption modulator (EAM) and the system further comprises a voltage source that is connected with the EAM. Functionally, the voltage source provides a bias voltage for altering an optical power of the optical signal with a DC offset. With this arrangement, the DC offset minimizes third order distortions of telecommunication signals transmitted on the fiber optic.

At the downstream end of the optical fiber, an optical receiver converts the optical signal into an RF signal which is then split using an RF splitter into a plurality of RF signals. From the RF splitter, each RF signal is routed to one of a plurality of downstream QAM modems. There, at each downstream QAM modem, an I-Q mixer is provided to down-shift each RF signal and reestablish the Q-component in-phase with the I-component. Also, each downstream QAM modem includes a downstream signal processor for de-mapping the I-component and the Q-component to reconstitute the original data stream.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a component schematic of the present invention showing the structural cooperation of system components;

FIG. 2 is a functional schematic of the present invention showing the signal processing requirements for an operation of the present invention;

FIG. 2A is a functional schematic of another embodiment having QAM modems that each include a pair of high-speed digital to analog (D/A) converters to modulate digital signals and produce up-shifted QAM signals; and

FIG. 3 is a schematic presentation of the present invention as shown in FIG. 2 when a plurality of different systems is connected to a same fiber optic.

### DESCRIPTION OF THE PREFERRED EMBODIMENTS

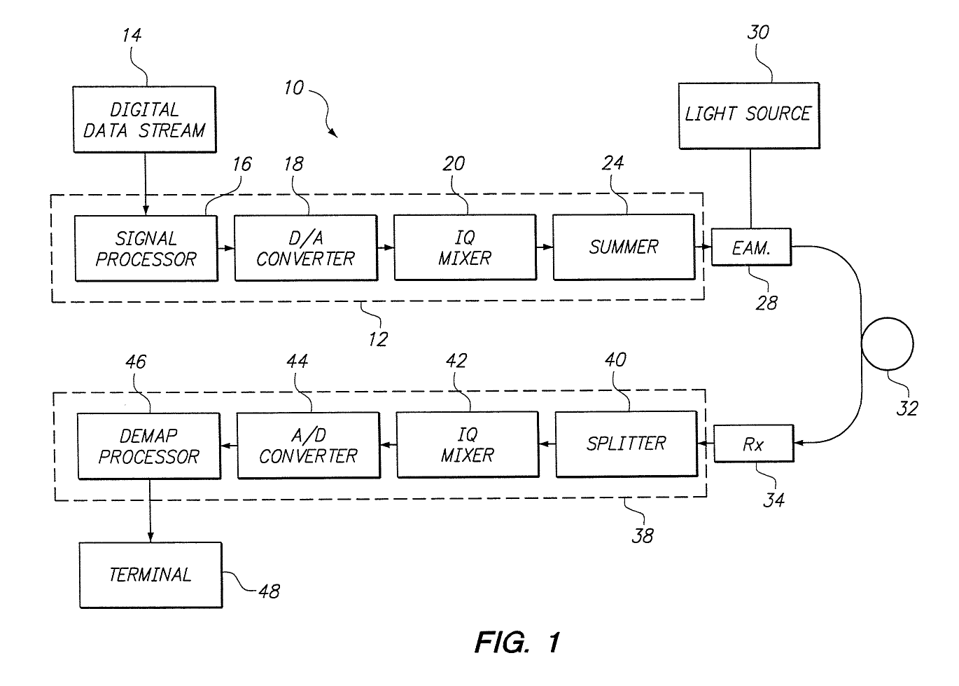

Referring initially to FIG. 1, a system for transporting digital signals is shown and is generally designated 10. As shown, the system 10 includes an upstream quadrature amplitude modulation (QAM) modem 12 which receives and process a digital data stream 14. For the system 10, the QAM modem 12 encodes the digital stream 14 onto a carrier signal by modulating both the amplitude and the phase of the carrier signal.

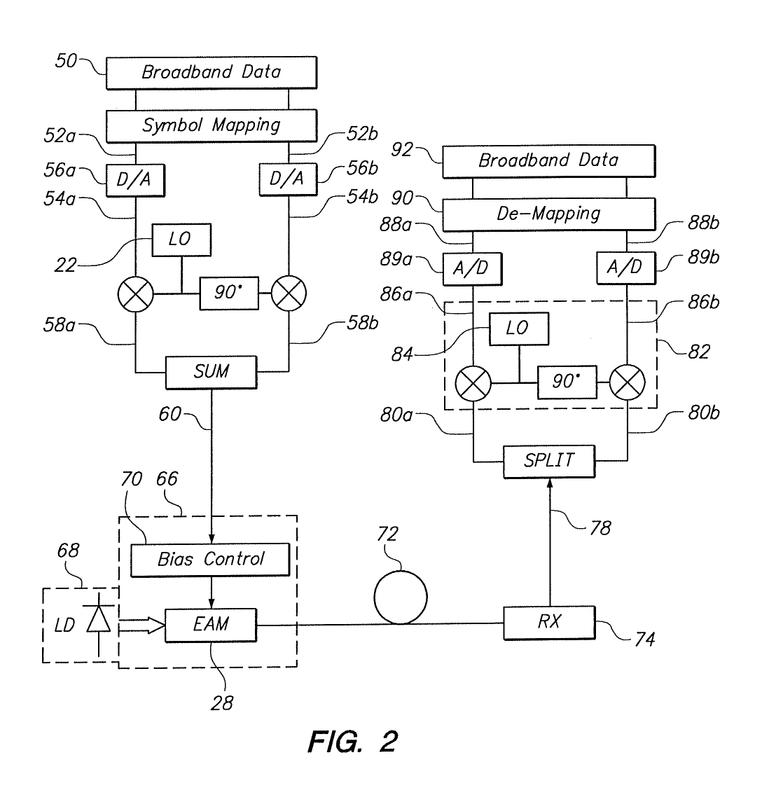

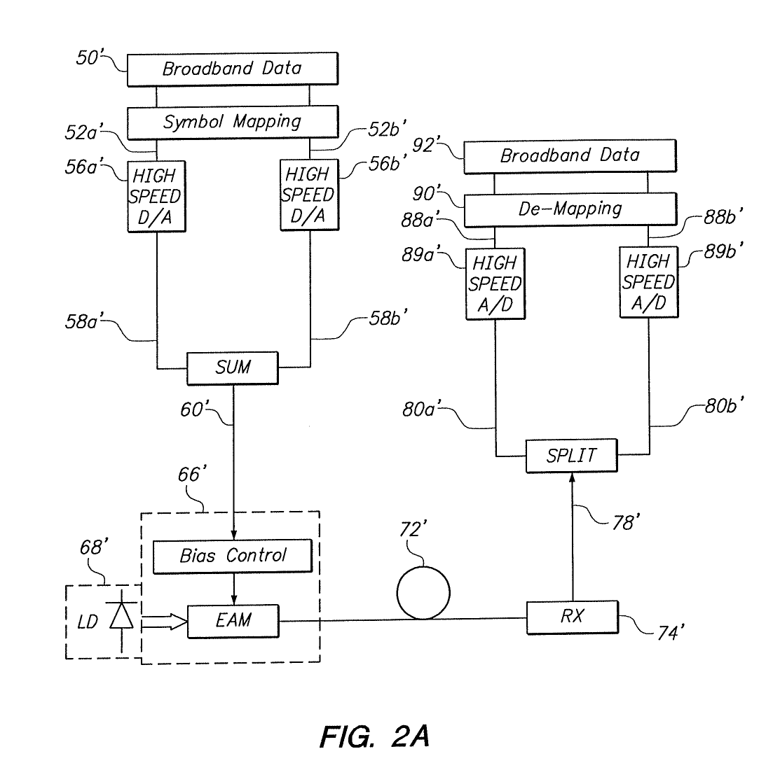

Structurally, FIG. 1 shows that the QAM modem 12 includes an upstream signal processor 16 for mapping symbols from the digital data stream 14 into an I-component and a Q-component. For example, each symbol can be two bits of the data stream 14, four bits of the data stream 14, sixteen bits of the data stream 14, or more. Also shown, each QAM modem 12 includes a digital to analog (D/A) converter 18 which converts the symbols to an analog signal. Filtering can be implemented at the (D/A) converter 18 in accordance with known filtering techniques to produce a filtered analog output. The QAM modem 12 also includes an upstream I-Q mixer 20 for establishing an I-component as an in-phase I-signal with an RF carrier frequency, f, and for phase shifting the Q-component into a quadrature-phase Q-signal with the same RF carrier frequency f. As best seen in FIG. 2, a local oscillator 22 can be incorporated into the upstream I-Q mixer 20 (FIG. 1) for use when establishing the phase relationship between the I-signal and the Q-signal. In addition, the frequency of the I-signal and the Q-signal are up-shifted during modulation into a sub-octave broadband wherein f is between a frequency I_{L} and a frequency f_{H}, wherein f_{H}<2 f_{L}. With this cooperative interaction of structure, composite second order distortions that can occur during optical transport are suppressed.

Referring back to FIG. 1, it can be seen that the QAM modem 12 includes a summer 24 which receives signals from the upstream I-Q mixer 20 and outputs a modulated carrier signal that is directed to an electro-absorption modulator (EAM) 28 and a light source 30. As detailed further below, the EAM 28 receives the signal output from the summer 24 and cooperates with the light source 30 to convert the signal to an optical signal that is directed into an optical fiber 32.

FIG. 1 further shows that at the downstream end of the optical fiber 32, an optical receiver 34 is provided to convert the optical signal into an RF signal. The RF signal is routed to a downstream QAM modem 38 for down-shifting and demodulation. As shown, the downstream QAM modem 38 includes, in order, a splitter 40, a downstream I-Q mixer 42, an analog to digital (ND) converter 44 and a de-mapping processor 46. Upon receipt of the signal, a splitter 40 separates the Q-component and the I-component and the downstream I-Q mixer 40 down-shifts the signal and reestablishes the Q-component in-phase with the I-component. The A/D converter 44 converts analog signals from the I-Q mixer 40 into digital signals. The input to the (ND) converter 44 can be filtered in accordance with known filtering techniques. Symbols in the digital signals are then de-mapped at the processor 46 to recover the original digital data stream (i.e. the digital data stream originally received by the upstream QAM modem 12) which is then directed to a terminal 48.

FIG. 2 illustrates an operation of the present invention. As seen there, broadband data 50 including a digital data stream is first processed (symbol mapped) to produce two digital signals 52a,b encoding symbols in the digital data stream. These digital signals 52a,b are converted to corresponding analog signals 54a,b encoding symbols by D/A conversion 56a,b. Analog signal 54a is then mixed with an output from local oscillator 22 to produce an I-component signal 58a as an in-phase I-signal with an RF carrier frequency, f. On the other hand, analog signal 54b is mixed with an output from local oscillator 22 that has been phase delayed by 90 degrees to produce a Q-component (quadrature-phase) signal 58b with the same RF carrier frequency f. In addition, the frequency of the I-signal and the Q-signal are up-shifted during modulation into a sub-octave broadband wherein f is between a frequency f_{L} and a frequency f_{H}, wherein f_{H}<2 f_{L}. With this cooperative interaction of structure, composite second order distortions that can occur during optical transport are suppressed. I-component signal 58a and Q-component signal 58b are then summed to produce QAM modulated signal 60.

Continuing with FIG. 2, for the present invention, the signal 60 is then converted into an optical signal by an electrical-optical (EO) converter 66 and a light source 68. For the operation shown in FIG. 2, the electrical-optical (EO) converter 66 includes an electro-absorption modulator (EAM 28) and the system further comprises a voltage source 70 that is connected with the EAM 28. Functionally, the voltage source 70 provides a bias voltage for altering an optical power of the optical signal output from the EAM 28 with a DC offset. With this arrangement, the DC offset minimizes third order distortions of telecommunication signals transmitted on the fiber optic 72.

At the downstream end of the fiber optic 72 shown in FIG. 2, the optical signal is received (box 74) and converted to an RF signal 78. The RF signal 78 is then split into signals 80a,b corresponding to the original I-component signal 58a and Q-component (quadrature-phase) signal 58b, respectively. Next, the signals 80a,b are processed by downstream I-Q mixer 82 having local oscillator 84 which down-shifts the signals and reestablishes the Q-component in-phase with the I-component and produces signals 86a,b corresponding to the original analog signals 54a,b, respectively. Analog signals 54a,b are then converted to digital signals 88a,b at (A/D) converters 89a,b to recover the original symbols which are then de-mapped (box 90) to recover the original broadband data (box 92).

FIG. 2A illustrates an operation of another embodiment of the present invention. As seen there, broadband data 50′ including a digital data stream is first processed (symbol mapped) to produce two digital signals 52a′,b′ encoding symbols in the digital data stream. These digital signals 52a′, 52b′ are then processed by high-speed digital to analog (D/A) converters 56a′, 56b′ that are programmed with appropriate software to produce an analog, up-shifted, I-component signal 58a′ and an analog, up-shifted, Q-component signal 58b′. In producing the I-component signal 58a′, a calculated LO signal having frequency, f, is used, wherein f is between a frequency f_{L} and a frequency f_{H}, and f_{H}<2 f_{L}. In producing the Q-signal output, a calculated LO signal having the frequency, f, is used with the Q-signal calculated LO signal differing in phase from the I-signal calculated LO signal by ninety degrees. In addition, the sampling rate used by the high-speed digital to analog (D/A) converters 56a′, 56b′ is typically larger than the calculated LO signal frequency, e.g. twice the frequency or greater, to ensure errorless signal reconstruction. For this embodiment, an I-Q mixer, such as the I-Q mixer having a physical local oscillator 22 as shown in FIG. 2 is not necessarily required. The I-component signal 58a′ and Q-component signal 58b′ are then summed to produce QAM modulated signal 60′. The benefit of this capability is that the digital signal is converted directly to and from an analog signal without the need for a hardware modulator or demodulator.

Continuing with FIG. 2A, for the present invention, the signal 60′ is then converted into an optical signal by an electrical-optical (EO) converter 66′ and a light source 68′, as described above for the embodiment shown in FIG. 2. At the downstream end of the fiber optic 72′ shown in FIG. 2A, the optical signal is received (box 74′) and converted to an RF signal 78′. The RF signal 78′ is then split into signals 80a′, 80b′ corresponding to the original I-component signal 58a′ and Q-component (quadrature-phase) signal 58b′, respectively. Next, the signals 80a′, 80b′ are processed by downstream, high-speed analog to digital (ND) converters 89a′, 89b′ which down-shift and demodulate the signals. The resulting digital signals 88a′, 88b′ are then de-mapped (box 90′) to recover the original broadband data (box 92′).

In another embodiment (not shown) the high speed D/A converters 56a′ and 56b′ and SUM can be combined into a single D/A converter with the summation being done digitally. Similarly, the high speed ND converters 89a′ and 89b′ and SPLIT can be combined into a single ND converter with the split being done digitally.

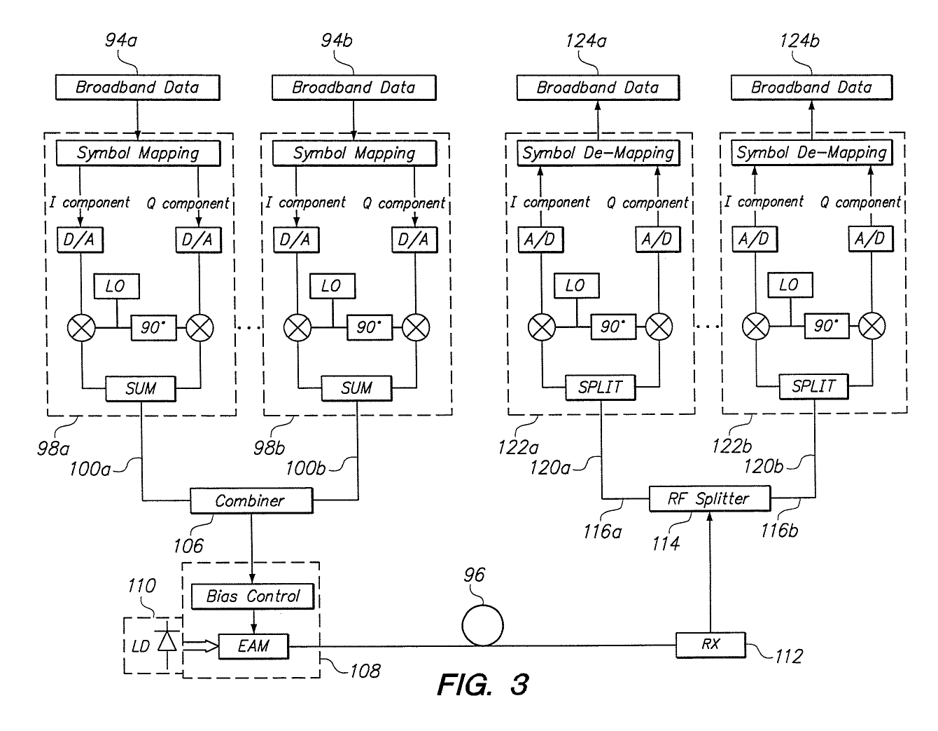

FIG. 3 illustrates an operation of the present invention in which two sources of broadband data 94a,b are processed and transported over a single fiber optic 96. As shown, broadband data 94a is modulated on a carrier signal by QAM modem 98a and broadband data 94b is modulated on a carrier signal by QAM modem 98b. QAM modulation includes the steps of symbol mapping, D/A conversion, mixing to produce an up-shifted I-component signal with an RF carrier frequency, f and an up-shifted Q-component (quadrature-phase) signal 58b and summing, as described above with reference to FIG. 2.

For the embodiment shown in FIG. 3, the frequency of each QAM modulated signal 100a,b resides in a single sub-octave broadband wherein f is between a frequency f_{L} and a frequency f_{H}, wherein f_{H}<2 f_{L}. With this cooperative interaction of structure, composite second order distortions that can occur during optical transport are suppressed. These signals are then combined (box 106) and the combined signal is then converted into an optical signal by an electrical-optical (EO) converter 108 and a light source 110 as described above with reference to FIG. 2.

At the downstream end of the fiber optic 96 shown in FIG. 3, the optical signal is received (box 112) and converted to an RF signal. The RF signal is then split (box 114) to recover signals 116a,b corresponding to the original modulated carrier signals 100a,b. The recovered signals 120a,b are then demodulated and down-shifted by downstream QAM modems 122a,b. During demodulation by downstream QAM modems 122a,b, the signals 122a,b are split, processed by downstream I-Q mixer which down-shifts the signals and reestablishes the Q-component in-phase with the I-component, converted from analog signals to digital signals to recover the original symbols and then de-mapped, as described above with reference to FIG. 2, to recover the original broadband data 124a,b (corresponding to original broadband data 94a,b).

Further details regarding the use of a DC offset to minimize third order distortions of telecommunication signals can be found in co-owned U.S. patent application Ser. No. 14/069,228, titled “System and Method for Broadband Transmissions on a Fiber Optic With Suppression of Second and Third Order Distortions” to Chen-Kuo Sun et al. filed on the same day as the present application, the entire contents of which are hereby incorporated by reference herein.

While the particular systems and methods for transmitting multi-octave telecommunication signals by up-shifting into a sub-octave bandwidth as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for transmitting sub-octave telecommunication signals from an upstream end of a fiber optic to a downstream end of the fiber optic, the system comprising:
an upstream signal processor for mapping a data stream into an I-component and a Q-component;
an upstream I-Q mixer for establishing the I-component as an in-phase I-signal with an RF carrier frequency f, and for phase shifting the Q-component into a quadrature-phase Q-signal with the same RF carrier frequency f and for producing an up-shifted I-signal and an up-shifted Q-signal and wherein the up-shifted I-signal and the up-shifted Q-signal are within a sub-octave broadband wherein f is between a frequency f_{L} and a frequency f_{H}, wherein f_{H}<2 f_{L};
a summer for uniting the I-signal and the Q-signal;
a light source for generating a light beam having a wavelength λ; and
an electrical-optical (EO) converter connected to the summer and to the light source to create an optical signal λ carrying the I-signal together with the Q-signal, for transmission over the fiber optic.

2. A system as recited in claim 1 further comprising:
a receiver connected to the downstream end of the fiber optic for receiving the optical signal λ;
an optical-electrical (OE) converter to separate and recreate the I-signal and the Q-signal from the optical signal λ;
a splitter for separating the I-signal from the Q-signal;
an I-Q mixer to reestablish the Q-component in-phase with the I-component and down-shift the I-signal and the Q-signal from the sub-octave broadband; and
a downstream signal processor for de-mapping the I-component and the Q-component to reconstitute the data stream.

3. A system as recited in claim 2 further comprising:
a local oscillator incorporated into the upstream I-Q mixer for use when establishing the phase relationship between the I-signal and the Q-signal for transmission on the optical signal λ; and
a local oscillator incorporated into the downstream I-Q mixer for maintaining the phase relationship between the I-signal and the Q-signal prior to reconstitution of the data stream.

4. A system as recited in claim 1 wherein the EO converter is an electro-absorption modulator (EAM) and the system further comprises a voltage source connected with the EAM to provide a bias voltage for altering an optical power of the light beam λ with a DC offset, wherein the DC offset minimizes third order distortions of telecommunication signals transmitted on the fiber optic, and the sub-octave broadband transmission minimizes second order distortions of the telecommunication signals transmitted on the fiber optic.

5. A system as recited in claim 1 wherein the light source is a laser diode.

6. A system as recited in claim 1 wherein the data stream is a digital data stream.

7. A system for transporting a plurality of digital data streams, the system comprising:
a plurality of upstream quadrature amplitude modulation (QAM) modems, each upstream QAM modem receiving a digital data stream and outputting a QAM output signal having a frequency within a single sub-octave frequency band;
an electrical-optical (EO) converter receiving the QAM signals and converting the QAM signals into an optical signal and directing the optical signal into an optical fiber;
an optical receiver downstream of the optical fiber converting the optical signal into a plurality RF signals; and
a plurality of downstream QAM modems, each downstream QAM modem receiving an RF signal downstream of the optical receiver, demodulating and down-shifting the received signal, and outputting a digital data stream.

8. A system as recited in claim 7 wherein each upstream QAM modem comprises:
an upstream signal processor for mapping symbols from a digital data stream into an I-component and a Q-component; and
an upstream I-Q mixer for establishing the I-component as an in-phase I-signal with an RF carrier frequency f, and for phase shifting the Q-component into a quadrature-phase Q-signal with the same RF carrier frequency f.

9. A system as recited in claim 8 further comprising:
a local oscillator incorporated into the upstream I-Q mixer for use when establishing the phase relationship between the I-signal and the Q-signal for transmission on the optical signal.

10. A system as recited in claim 9 further comprising:
a summer incorporated into the upstream I-Q mixer for uniting the I-signal and the Q-signal.

11. A system as recited in claim 7 wherein the EO converter is an electro-absorption modulator (EAM) and the system further comprises a voltage source connected with the EAM to provide a bias voltage for altering an optical power of the optical signal with a DC offset, wherein the DC offset minimizes third order distortions of telecommunication signals transmitted on the optical fiber, and the sub-octave broadband transmission minimizes second order distortions of the telecommunication signals transmitted on the optical fiber.

12. A system as recited in claim 7 wherein each upstream quadrature amplitude modulation (QAM) modem comprises a pair of high-speed digital to analog (D/A) converters.

13. A system as recited in claim 7 further comprising an RF combiner receiving QAM signals from the plurality of QAM modems and outputting a combined signal to the electrical-optical (EO) converter.

14. A method for transporting a plurality of digital data streams, the method comprising the steps of:
modulating each digital data stream to output a respective quadrature amplitude modulation (QAM) signal with each output QAM signal having a frequency within a single sub-octave frequency band;
converting the QAM signals into an optical signal and directing the optical signal into an optical fiber;
receiving the optical signal at a downstream end of the optical fiber and converting the optical signal into a plurality RF signals; and
demodulating and down-shifting the frequency of each RF signal downstream of the optical receiver to output a respective digital data stream.

15. A method as recited in claim 14 wherein the step of modulating each digital data stream to output a respective quadrature amplitude modulation (QAM) signal comprises the sub-step of mapping symbols from the digital data stream into an I-component and a Q-component.

16. A method as recited in claim 15 wherein the step of modulating each digital data stream to output a respective quadrature amplitude modulation (QAM) signal comprises the sub-step of using an upstream I-Q mixer for establishing the I-component as an in-phase I-signal with an RF carrier frequency f, and for phase shifting the Q-component into a quadrature-phase Q-signal with the same RF carrier frequency f.

17. A method as recited in claim 16 wherein the step of modulating each digital data stream to output a respective quadrature amplitude modulation (QAM) signal comprises the sub-step of using a summer for uniting the I-signal and the Q-signal.

18. A method as recited in claim 17 wherein the step of converting the RF signals into an optical signal is accomplished using a light source for generating a light beam having a wavelength λ and an electrical-optical (EO) converter connected to the summer and to the light source to create an optical signal λ carrying the I-signal together with the Q-signal, for transmission over the optical fiber.

19. A method as recited in claim 18 wherein the EO converter is an electro-absorption modulator (EAM) and the system further comprises a voltage source connected with the EAM to provide a bias voltage for altering an optical power of the optical signal with a DC offset, wherein the DC offset minimizes third order distortions of telecommunication signals transmitted on the optical fiber, and the sub-octave broadband transmission minimizes second order distortions of the telecommunication signals transmitted on the optical fiber.

20. A method as recited in claim 14 further comprising the step of receiving QAM signals at an RF combiner and outputting a combined signal for use in the step of converting the QAM signals into an optical signal.
